(19) United States
(12) Patent Application Publication
(10) Pub. No.: US 2007/0026157 A1
(43) Pub. Date: Feb. 1, 2007

(54) Flame coating method and corresponding device

(76) Inventors: Alain Tournier, Nancy (FR); Denis Girardin, Maidieres (FR); Michel Secondy, Augny (FR); Alain Secondy, Augny (FR)

Correspondence Address: SUGHRUE MION, PLLC, 2100 PENNSYLVANIA AVENUE, N.W., SUITE 800, WASHINGTON, DC, 20037, US

(21) Appl. No.: 10/553,597

(22) PCT Filed: Apr. 16, 2004
(86) PCT No.: PCT/FR04/00952

§ 371 Date: Oct. 18, 2005

(30) Foreign Application Priority Data
Apr. 23, 2003 (FR) 0304986

(51) Int. Cl. B05D 1/08; C23C 4/00; B05C 5/00

(52) U.S. Cl. 427/446; 118/300

(57) ABSTRACT

The method for covering an object to be coated (40) with a meltable covering comprises the following steps: establishment of a flame (44), the direction of the flame (F) thereof being oriented towards the object to be coated and introduction of an amount of meltable covering material into the flame. The temperature of the flame is sufficiently high in order to result in the at least partial melting of the meltable material. The speed of the flame is chosen in such a way that the meltable covering material thus melted is projected onto the object to be coated. At least one part of the amount of meltable coating material is in a melted stated when it impacts upon the object to be coated. The amount of meltable covering material includes powder. The invention can be used for coating cast iron pipes.

The present invention relates to a method for coating an object to be coated with a meltable coating material comprising the steps:
production of a flame having a maximum flame speed and a flame direction which coincides with a flame axis and which is directed towards the object to be coated;
introduction of a quantity of the meltable coating material into the flame;
the maximum flame speed and the distance between the object to be coated and the flame being selected so that the meltable coating material is projected onto the object to be coated and so that at least a portion of the quantity of the meltable coating material is in the molten state at the time of impact on the object to be coated.

The invention is applicable in particular to methods for coating cast iron pipes with a layer of zinc or a Zn—Al alloy.

Flame powder coating methods are known. In such methods, a coating material is introduced in the form of wire into a flame, which melts the material, so that droplets of coating material are formed. These droplets are then carried by the combustion gases of the flame and projected onto an object which is to be coated.

Known flame powder coating methods have an efficiency of approximately 60%. The efficiency is defined by the relationship of the quantity of material which adheres effectively to the object which is to be coated relative to the quantity of material introduced into the flame. Approximately 10% of the material is lost by evaporation. The rest of the material, therefore approximately 30% of the material, does not adhere to the object which is to be coated and accumulates in the form of residual powder.

This degraded residual powder is difficult to recycle and has only a low economic value, in particular in the case of impure powders, such as mixtures of different materials and/or alloys such as Zn—Al.

The object of the present invention is to provide a flame coating method which is economical.

To this end, the invention relates to a method of the above-mentioned type, characterised in that the quantity of meltable coating material comprises powder constituted by particles, and in that the flame has a temperature which is sufficiently low for the particles of the powder not to be completely evaporated and which is sufficiently high for the particles of the powder to be at least partially melted.

According to other embodiments, the method according to the invention can comprise one or more of the following features:
the quantity of material is constituted by powder;
the particles have a maximum dimension of less than 1000 μm, preferably less than 800 μm and in particular less than 500 μm;
the particles have a minimum dimension of greater than 20 μm, preferably greater than 40 μm and in particular greater than 60 μm;
the material is introduced into the flame in at least one introduction direction and the introduction direction comprises a radial component relative to the flame axis;
the introduction direction is directed substantially radially relative to the flame axis;
the object to be coated extends along a longitudinal axis and the introduction direction has a component which extends in parallel with the longitudinal axis; and
the introduction direction extends substantially in parallel with the longitudinal axis of the object to be coated;
the material is introduced into the flame in at least two introduction directions and these two directions extend symmetrically at one side and the other of a plane which comprises the flame axis and which extends perpendicularly to the longitudinal axis of the object to be coated;
the powder comprises at least 50% by weight of a metal or an alloy whose melting point is between 400° C. and 500° C., preferably between 425° C. and 475° C.;
the powder is constituted by an alloy comprising at least 50% by weight of Zn, in particular at least 85% by weight of Zn and preferably at least 95% by weight of Zn;
the residual portion of the alloy comprises aluminium, and is in particular constituted by aluminium;
the maximum flame speed is between 500 m/s and 2000 m/s, and is preferably between 700 m/s and 900 m/s;
at least a portion of the powder is a waste product powder;
the waste product powder originates from a method of coating by projection, and in particular from an arc wire coating method using a wire or a cord of meltable coating material as the source material;
that portion of the powder is obtained by sieving a quantity of unprocessed waste product powder;
at least that portion of the powder is subjected to a drying or deoxidation operation before being introduced into the flame; and
the maximum temperature of the flame is between 2000° C. and 3000° C., preferably between 2250° C. and 2750° C. and in particular between 2400° C. and 2600° C.

The invention further relates to a device for coating by means of a flame, suitable for carrying out the method according to any one of the preceding claims, of the type comprising:
a burner which can be connected to a source of combustible gas and which can produce a flame in a flame axis,
means for introducing a meltable coating material into the flame,
   characterised in that the means for introducing the meltable coating material are suitable for introducing the meltable coating material into the flame in the form of powder.

According to other embodiments, the device according to the invention can comprise one or more of the following features:
the introduction means comprise an injector which can introduce a mixture of coating material powder/conveying gas into the flame in an introduction direction;
the introduction direction is directed substantially radially relative to the flame axis; and
the device further comprises a mixer for the coating material powder/conveying gas comprising a powder inlet, a conveying gas inlet which can be connected to a conveying gas source and an outlet for the mixture of coating material powder/conveying gas, the mixer can mix the powder with a flow of conveying gas and the outlet for the mixture of coating material powder/conveying gas is connected to at least one injector.

Owing to the parameters indicated above, such as the speed of the gas, the temperature of the flame and the injection location, satisfactory operation of the device and a uniform coating are obtained.

The invention will be better understood from a reading of the description below which is given purely by way of example, with reference to the appended drawings, in which:

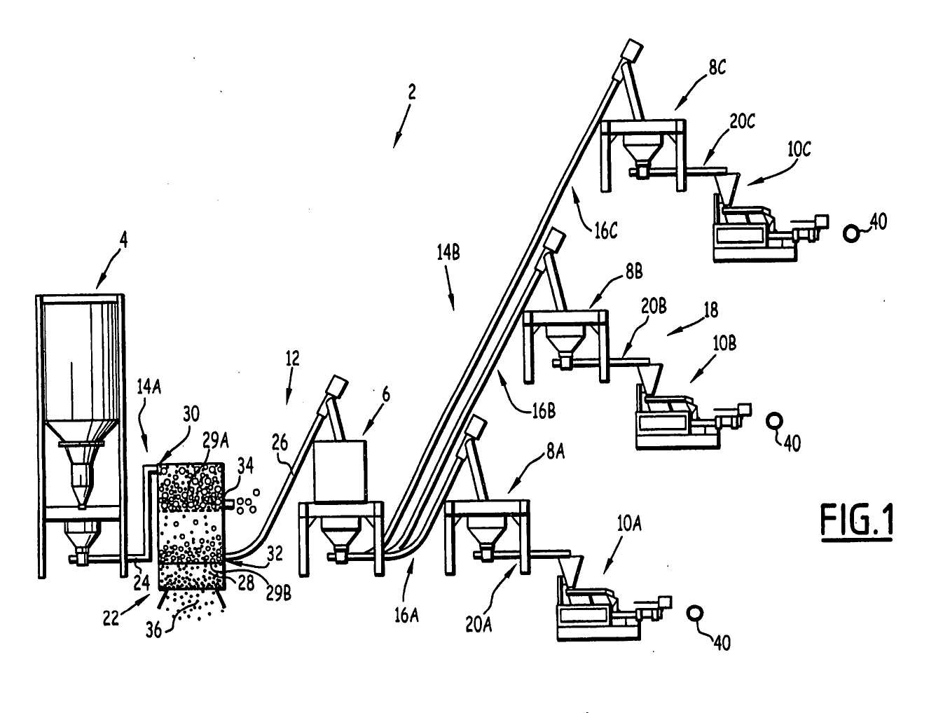

FIG. 1 shows schematically an installation comprising coating devices according to the invention;

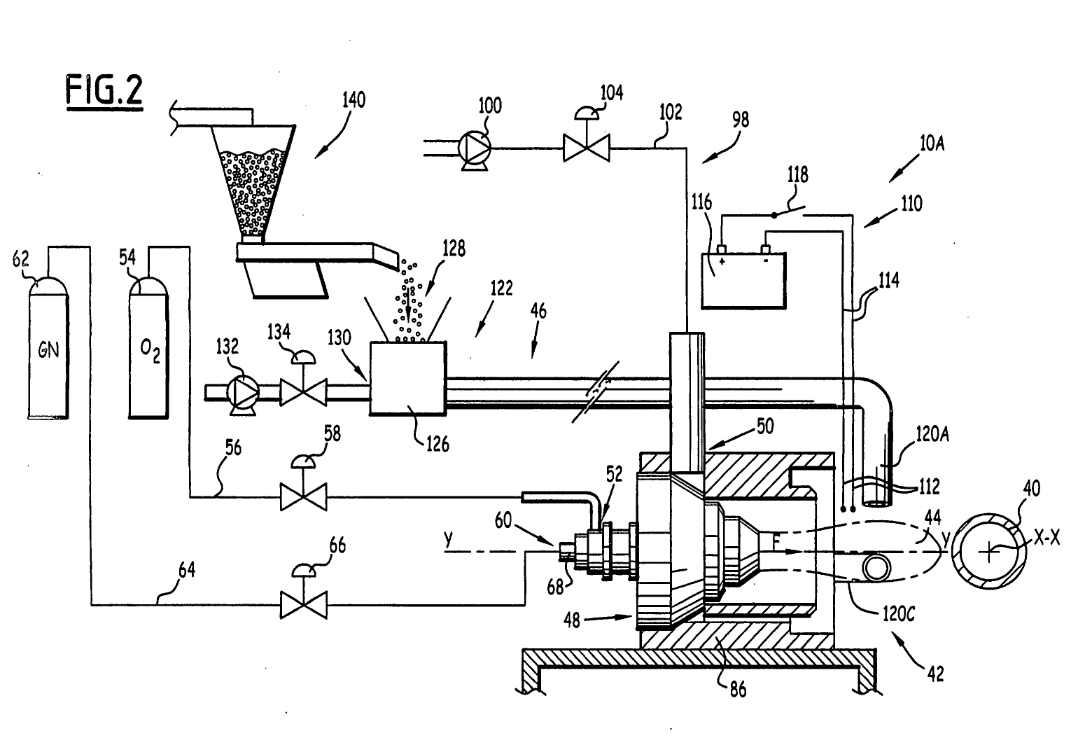

FIG. 2 shows schematically a coating device according to the invention;

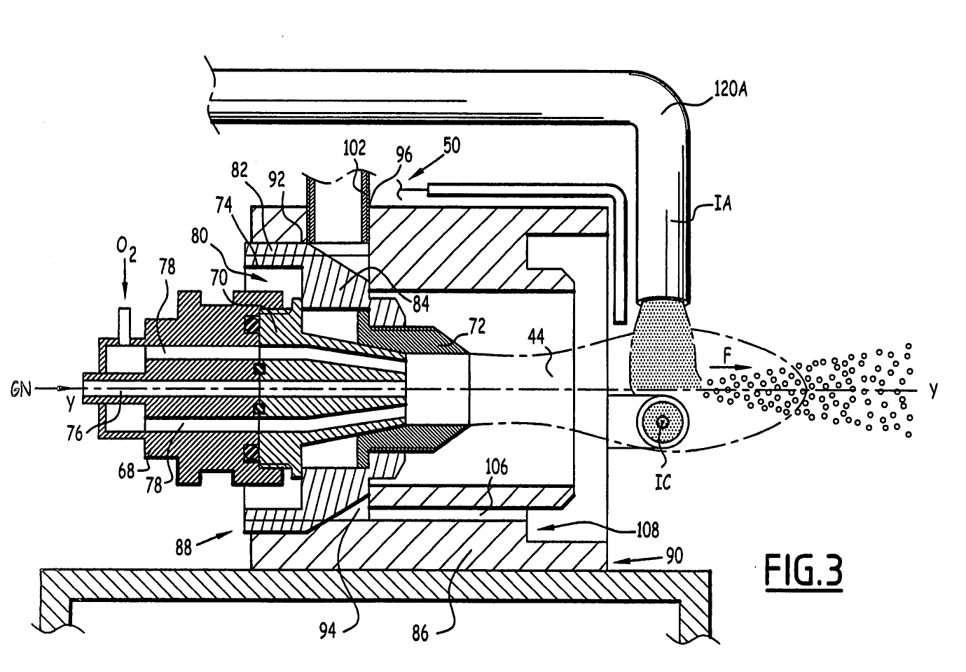

FIG. 3 is a longitudinal section of part of the coating device of FIG. 2; and

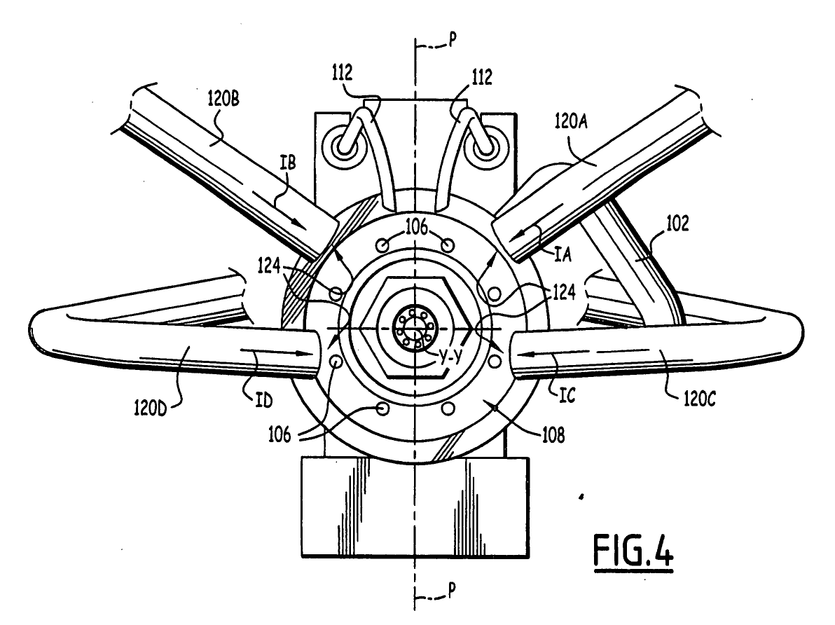

FIG. 4 is a front view of the part of the coating device of FIG. 3.

FIG. 1 illustrates an installation for flame coating according to the invention, generally designated 2.

The installation comprises a device 4 for recovering unprocessed powder, a main reservoir 6, three supply reservoirs 8A, 8B, 8C and three flame coating devices 10A, 10B, 10C.

The device 4 for recovering unprocessed powder is suitable for recovering directly, that is to say, without processing, residual powders or waste product powders produced when known coating methods are carried out. Such methods use a wire or a cord as the base material and produce powders of residual coating material which are constituted by particles whose maximum dimension is generally of between 0 μm and 2000 μm.

Such powders generally comprise alloy particles based on a metal having a low melting point of between 400° C. and 450° C. and preferably of between 425° C. and 475° C.

The alloy is, for example, an alloy based on Zn, which comprises at least 50% by weight of Zn, but preferably more than 85% by weight of Zn, and in particular more than 95% by weight of Zn.

The residual portion of the alloy comprises, for example, aluminium, and is preferably constituted by aluminium.

The installation 2 further comprises first means 12 for supplying coating material powder which are able to supply the main reservoir 6.

These first supply means 12 comprise a first conveyor 14A whose inlet is connected to an outlet of the device 4 for recovering unprocessed powder and whose outlet opens into the main reservoir 6.

The installation 2 further comprises second means 14B for supplying coating material powder which are able to supply each of the supply reservoirs with coating material powder from the main reservoir 6.

In this case, these second supply means 14B are constituted by three conveyors 16A, 16B, 16C, each of which is connected to an outlet of the main reservoir and to an inlet of the supply reservoirs 8A, 8B, 8C.

Third powder supply means 18 are suitable for conveying powder from each of the supply reservoirs 8A, 8B, 8C towards each of the coating devices 10A, 10B, 10C. In this case, these third supply means 18 are constituted by three screw type conveyors 20A, 20B, 20C.

A device 22 for processing unprocessed powder is arranged in the first conveyor 14A and separates it into an upstream portion 24 and a downstream portion 26.

The device 22 for processing unprocessed powder is formed by a sieving device 28. The sieving device 28 can separate the particles of the powder, the maximum dimension and the minimum dimension of which are within a predetermined range. The sieving device 28 comprises two sieves, a coarse sieve 29A and a fine sieve 29B. The coarse sieve 29A is arranged above the fine sieve 29B. The sieving device 28 further comprises an inlet 30, through which the unprocessed powder originating from the recovery device 4 is introduced above the coarse sieve 29A by means of the upstream portion 24. A first outlet 32 of the sieving device, which outlet 32 is arranged between the coarse sieve 29A and the fine sieve 29B, is connected to the downstream portion 26 of the first conveyor 14A. The sieving device is provided with two other outlets 34, 36, one upstream of the coarse sieve 29A and one downstream of the fine sieve 29B. These outlets 34, 36 are provided for particles whose maximum or minimum dimension is greater than or less than the above-mentioned limits.

In this case, the maximum dimension of each of the particles is less than 1000 μm, preferably less than 800 μm and in particular less than 500 μm. At the first outlet 32 of the sieving device 28, the powder is further constituted by particles whose minimum dimension is greater than 20 μm, preferably greater than 40 μm and in particular greater than 60 μm.

The coating device 10A will be described by way of example below. The other two coating devices 10B, 10C are identical.

FIG. 2 is a schematic view of the coating device 10A according to the invention and an object to be coated.

The object to be coated is a pipe 40 which is generally of a hollow cylindrical shape and which has a longitudinal and horizontal axis X-X. The pipe is, for example, of metal, and in particular of cast iron. The pipe 40 is fixed to a support (not shown) and can be caused to rotate about the longitudinal axis X-X thereof and moved in translation relative to the coating device 10 along this axis.

The coating device 10 comprises a burner 42 which is illustrated partially sectioned in FIG. 2, and a device 46 for introducing coating material powder into a flame 44.

The burner 42 can produce the flame 44 in a horizontal flame direction F which is defined by flame axis Y-Y and which is directed towards the pipe 40. The flame axis Y-Y and longitudinal axis X-X together define an angle not equal to 0°. These axes define plane P-P which extends perpendicularly to axis X-X and which coincides with axis Y-Y (see FIG. 4).

The burner 42 is formed by a burner head 48 and means 50 for cooling and guiding the flame 44.

The burner head 48 is provided with a combustive gas inlet 52 which is connected to a source 54 of combustive gas, such as oxygen, by means of a combustive gas line 56 and a first valve 58 for controlling flow rate and pressure.

The burner head 48 is provided with a combustible gas inlet 60 which is connected to a source 62 of combustible gas, such as natural gas, acetylene or propane, by means of a combustible gas line 64 and a second valve 66 for controlling pressure and flow rate.

The burner head 48 and part of the device 46 for introducing powder are illustrated to a larger scale in FIG. 3, the burner head 48 being illustrated longitudinally sectioned.

The burner head 48 generally rotates about axis Y-Y. It comprises, arranged in succession one behind the other and in the direction of flame F, a mixer 68, a combustible gas nozzle 70 and a combustive gas nozzle 72. The combustive gas nozzle 72 is secured by a nozzle support 74. The mixer 68 forms the combustible gas inlet 60 and the combustive gas inlet 52 of the burner 42. The mixer 68 and the combustible gas nozzle 70 comprise a combustible gas passage 76 which is coaxial with axis Y-Y and a plurality of combustive gas passages 78 which are distributed regularly around the combustible gas passage 76. These components are known per se.

The combustible gas passage 76 of the mixer 68 has a diameter which is suitable for a high flow rate of gas.

The relationship of the diameters of the passages 76 and 78 is suitable for producing a stoichiometric gas mixture with a high flow rate.

The combustive gas nozzle support 74 is a component which rotates about axis Y-Y and which comprises a stepped through-hole 80 whose cross-section decreases starting from the rear end towards the front. The combustive gas nozzle support 74 comprises a threaded cylindrical base 82, to which a frustoconical outer portion 84 is connected.

The means 50 for cooling and guiding the flame 44 comprise a cooling sleeve 86, in which the burner head 48 is arranged.

The sleeve 86 comprises a gas inlet end 88 and a flame outlet end 90.

The sleeve 86 comprises, at the side of the inlet end 88, a stepped threaded hole 92, into a portion of which the base 82 of the combustive gas nozzle support 74 is screwed so that the frustoconical portion 84 and the rest of the stepped hole 92 form an annular cooling chamber 94 which surrounds an axial portion of the nozzle support 74.

A radial inlet hole 96 for cooling gas is arranged in the sleeve 86, which hole 96 opens into the cooling chamber 94 and which is connected to cooling air supply means 98.

As illustrated in FIG. 2, these cooling air supply means 98 comprise a first air compressor 100 which is connected to a compressed air line 102 which opens into the cooling chamber 94 and in which a third control valve 104 is fitted.

The sleeve 86 further comprises holes 106 which extend axially from the cooling chamber 94 and which open at a front surface of the sleeve 86, which surface is arranged at the side of the outlet end 90 and which is formed by an annular groove 108 which is open in the direction of the flame F in order to allow confinement of the flame without the initial flow being disrupted.

As illustrated in FIG. 4, the sleeve 86 comprises eight holes 106.

The burner 42 is further provided with a flame ignition device 110 (see FIG. 2). This ignition device 110 comprises two ignition electrodes 112 which terminate near the outlet end 90 of the sleeve 86. The ignition electrodes 112 are connected to a source 116 of electricity by wires 114. A switch 118 is interposed in one of the wires 114 and allows the electrodes 112 to be controlled.

The device 46 for introducing powder into the flame 44 comprises four injectors 120A, 120B, 120C, 120D of known type (see FIG. 4) and a device 122 for supplying a mixture of powder and air, to which device 122 the injectors 120A, 120B, 120C, 120D are connected.

Each injector 120A, 120B, 120C, 120D is substantially constituted by a tube which has a powder outlet 124 and which is suitable for introducing coating material powder into the flame 44 in an introduction direction IA to ID. Each of the directions of introduction IA to ID is directed substantially radially to flame axis Y-Y. The two introduction directions IA and IB of the two injectors 120A, 120B are inclined downwards at 45°, whereas the introduction directions IC and ID of the two injectors 120C, 120D extend substantially horizontally in parallel with axis X-X and are directed one towards the other. Therefore, the introduction directions IA to ID each have a component which extends along longitudinal axis X-X of the pipe 40.

The introduction directions IA, IB and IC, ID are arranged symmetrically relative to plane P-P.

Owing to this arrangement, the particles of the powder which are projected towards the pipe 40 are distributed over an imaginary mark whose preferential direction extends along axis X-X. Consequently, few particles are projected above or below the pipe 40.

A symmetrical position relative to a horizontal axis would give the same result should the pipe 40 be arranged in such a manner that axis X-X thereof extends vertically.

The device 122 for supplying a mixture of powder and air comprises a chamber 126 for mixing powder and air having an inlet hopper 128 for the coating material powder and a compressed air inlet 130 which is connected to means for supplying compressed air which are formed by a second compressor 132 and a fourth control valve 134.

A metering device 140, in this case a vibration type conveyor, is arranged above the inlet of the inlet hopper 128.

The metering device 140 is suitable for being supplied with coating material powder by the screw type conveyor 20A.

The installation according to the invention operates as follows.

Firstly, the cast iron pipe 40 is installed on the support (not illustrated) and is caused to rotate about axis X-X.

Next, the valves 58, 66 are opened. The pressure of the combustible gas is adjusted to approximately 3 bars if propane is used as the combustible gas. The pressure of the combustive gas is adjusted to approximately 8 bars if oxygen is used as the combustive gas.

The flow rate of combustible gas is adjusted in order to obtain a power which can reach 70 kW. With regard to the flow rate of the combustive gas, it is adjusted to produce a stoichiometric flame. The power of 70 kW corresponds to a flow rate of the order of 7 Nm³/h of natural gas.

The first compressor 100 is started and the cooling chamber 94 is supplied with compressed air, for example, at a pressure of approximately 2 bars.

Next, the flame 44 is ignited by the ignition device 110. The flame 44 which is produced has a power of between 30 kW and 70 kW.

The maximum temperature of the flame 44 is between 2000° C. and 3000° C., preferably between 2250° C. and 2750° C. and in particular between 2400° C. and 2600° C.;

The maximum speed of the gases of the flame 44 is between 500 m/s and 2000 m/s and preferably between 700 m/s and 900 m/s.

The device 122 for supplying the mixture is then started and conveys a mixture of air and powder towards the injectors 120A, 120B, 120C, 120D. The flow rate of powder of a single injector 120A, 120B, 120C, 120D is between 15 kg/h and 50 kg/h, and is preferably approximately 35 kg/h per injector. The flow rate of powder of all of the injectors is between 60 kg/h and 250 kg/h.

The injectors 120A, 120B, 120C, 120D introduce the mixture of air and powder into the flame 44 in the directions of introduction IA to ID. The speed of injection of the powder into the flame 44 is between 20 m/s and 50 m/s.

The powder particles are carried by the flame 44 in direction F thereof. They are completely melted by the flame 44 and form droplets of molten coating material. Owing to the fact that the dimensions of the particles are within the above-mentioned range, the particles are completely melted, but without evaporating. The droplets are discharged from the flame 44 in a manner which is fast enough to prevent the evaporation thereof.

The droplets are projected onto the pipe 40. The distance between the flame 44 and the pipe 40 is selected so that the droplets are still in the liquid state when they strike the pipe.

The droplets adhere to the pipe 40 and solidify, forming a coating.

In order to coat the outer surface along the length of the pipe 40, the pipe 40 is moved in translation along axis X-X.

The method according to the invention allows an object to be coated with a layer of coating at a high rate of flow in terms of mass of powder, whilst using the powder recovered from preceding coating operations. The method according to the invention further achieves an efficiency similar to that of flame coating methods which use a coating material in the form of wire, that is to say, in the order of 60%.

The device according to the invention and the operating parameters allow a powder which is constituted by an alloy having a low melting point (approximately 450° C.), such as Zn₈₅Al₁₅, to be used as the coating material.

In general terms, the powder is constituted by at least 50% of a metal or an alloy whose melting point is between 400° C. and 500° C., preferably between 425° C. and 475° C.

As a variant, the mixing chamber 126 can be connected to a source of conveying gas other than air, for example, a source of inert gas.

As a further variant, the coating device can be provided with a number of injectors other than four, for example, two injectors or six injectors.

In addition, the powder processing device can comprise a device for drying and/or deoxidising the powder in order to improve the flow properties of the powder and/or the quality of the coating.

1. Method for coating an object (40) to be coated with a meltable coating material comprising the steps:
production of a flame (44) having a maximum flame speed and a flame direction (F) which coincides with a flame axis (Y-Y) and which is directed towards the object (40) to be coated;
introduction of a quantity of the meltable coating material into the flame (44);
the maximum flame speed and the distance between the object (40) to be coated and the flame (44) being selected so that the meltable coating material is projected onto the object (40) to be coated and so that at least a portion of the quantity of the meltable coating material is in the molten state at the time of impact on the object (40) to be coated,
characterised in that the quantity of meltable coating material comprises powder constituted by particles, and
in that the flame (44) has a temperature which is sufficiently low for the particles, of the powder not to be completely evaporated and which is sufficiently high for the particles of the powder to be at least partially melted.

2. Coating method according to claim 1, characterised in that the quantity of material is constituted by powder.

3. Coating method according to claim 1, characterised in that the particles have a maximum dimension of less than 1000 μm, preferably less than 800 μm and in particular less than 500 μm.

4. Coating method according to claim 1, characterised in that the particles have a minimum dimension of greater than 20 μm, preferably greater than 40 μm and in particular greater than 60 μm.

5. Coating method according to claim 1, characterised in that the material is introduced into the flame (44) in at least one introduction direction (IA to ID), and in that the introduction direction (IA to ID) comprises a radial component relative to the flame axis (Y-Y).

6. Coating method according to claim 5, characterised in that the introduction direction (IA to ID) is directed substantially radially relative to the flame axis (Y-Y).

7. Coating method according to claim 5, characterised in that the object 40 to be coated extends along a longitudinal axis (X-X), and in that the introduction direction (IA to ID) has a component which extends in parallel with the longitudinal axis (X-X).

8. Coating method according to claim 7, characterised in that the introduction direction (IC, ID) extends substantially in parallel with the longitudinal axis (X-X) of the object (40) to be coated.

9. Coating method according to claim 7, characterised in that the material is introduced into the flame (44) in at least two introduction directions (IA, IB; IC, ID), and in that these two directions extend symmetrically at one side and the other of a plane (P-P) which comprises the flame axis (Y-Y) and which extends perpendicularly to the longitudinal axis (X-X) of the object to be coated.

10. Coating method according to claim 1, characterised in that the powder comprises at least 50% by weight of a metal or an alloy whose melting point is between 400° C. and 500° C., preferably between 425° C. and 475° C.

11. Coating method according to claim 10, characterised in that the powder is constituted by an alloy comprising at least 50% by weight of Zn, in particular at least 85% by weight of Zn and preferably at least 95% by weight of Zn.

12. Coating method according to claim 11, characterised in that the residual portion of the alloy comprises aluminium, and is in particular constituted by aluminium.

13. Coating method according to claim 1, characterised in that the maximum flame speed is between 500 m/s and 2000 m/s, and is preferably between 700 m/s and 900 m/s.

14. Coating method according to claim 13, characterised in that at least a portion of the powder is a waste product powder.

15. Coating method according to claim 14, characterised in that the waste product powder originates from a method of coating by projection, and in particular from an arc wire coating method using a wire or a cord of meltable coating material as the source material.

16. Coating method according to claim 14, characterised in that that portion of the powder is obtained by sieving a quantity of unprocessed waste product powder.

17. Coating method according to claim 16, characterised in that at least that portion of the powder is subjected to a drying or deoxidation operation before being introduced into the flame (44).

18. Coating method according to claim 1, characterised in that the maximum temperature of the flame is between 2000° C. and 3000° C., preferably between 2250° C. and 2750° C. and in particular between 2400° C. and 2600° C.

19. Device for coating by means of a flame, suitable for carrying out the method according to claim 1, of the type comprising:
a burner (42) which can be connected to a source of combustible gas (62) and which can produce a flame (44) in a flame axis (Y-Y),
means (46) for introducing a meltable coating material into the flame,
characterised in that the means (46) for introducing the meltable coating material are suitable for introducing the meltable coating material into the flame (44) in the form of powder.

20. Device according to claim 19, characterised in that the introduction means (46) comprise an injector (120A, 120B, 120C, 120D) which can introduce a mixture of coating material powder/conveying gas into the flame (44) in an introduction direction (IA, IB, IC, ID).

21. Device according to claim 20, characterised in that the introduction direction (IA, IB, IC, ID) is directed substantially radially relative to the flame axis (Y-Y).

22. Device according to claim 1, characterised in that it further comprises a mixer (120) for the coating material powder/conveying gas comprising a powder inlet (128), a conveying gas inlet (130) which can be connected to a conveying gas source (132) and an outlet for the mixture of coating material powder/conveying gas, in that the mixer (120) can mix the powder with a flow of conveying gas and in that the outlet for the mixture of coating material powder/conveying gas is connected to at least one injector (120A, 120B, 120C, 120D).
